(19) United States
(12) Patent Application Publication
(10) Pub. No.: US 2014/0328263 A1
(43) Pub. Date: Nov. 6, 2014

(54) DEVICE AND METHOD FOR SCHEDULING PACKET TRANSMISSION

(71) Applicant: Industry-Academic Cooperation Foundation, Yonsei University, Seoul (KR)

(72) Inventors: Jong-Moon Chung, Seoul (KR); Sung-Woong Jo, Seoul (KR); Myong Hwan Ahn, Suwon (KR)

(73) Assignee: Industry-Academic Cooperation Foundation, Yonsei University, Seoul (KR)

(21) Appl. No.: 14/265,988

(22) Filed: Apr. 30, 2014

(30) Foreign Application Priority Data
May 1, 2013 (KR) 10-2013-0049084

(51) Int. Cl. H04W 72/12

(52) U.S. Cl. CPC H04W 72/12
USPC 370/329

(57) ABSTRACT

A device and method for scheduling packet transmission are disclosed. The disclosed device includes: an interface unit configured to transmit and receive a packet; a controller configured to calculate a local time and an ARQ time from a packet to be transmitted, where the local time is determined in proportion to a packet delay bound, and the ARQ time is determined based on the local time and the packet delay bound; a queue in which the packet to be transmitted is inputted; and a scheduler configured to determine a transmission order of packets inputted in the queue based on at least one of the local time and the ARQ time. The disclosed device provides the advantage of efficient packet transmission in a multi-hop wireless network.

### CROSS-REFERENCE TO RELATED APPLICATIONS

This application claims the benefit of Korean Patent Application No. 10-2013-0049084, filed with the Korean Intellectual Property Office on May 1, 2013, the disclosure of which is incorporated herein by reference in its entirety.

### TECHNICAL FIELD

The present invention relates to a device and method for scheduling packet transmission.

### RELATED ART

As the amount of multimedia traffic increases for real-time services involving digital audio and digital video applications, various techniques are being developed to guarantee the QoS of each packet. A scheduling algorithm can be regarded as a representative example of a technique for ensuring packet QoS, and various scheduling algorithms are being developed in the field of wired networks. Existing scheduling algorithms in wired networks include EDF (Earliest Deadline First), CEDF (Coordinated EDF), G-EDF (Global-EDF), etc. EDF scheduling is an algorithm for determining transmission order by assigning higher priority to packets that have smaller delay bounds, and CEDF scheduling and G-EDF scheduling are algorithms for determining transmission order by assigning higher priority to packets having smaller delay bounds while incorporating coordination between nodes along the packet transmission path and were designed to guarantee QoS in packets having multi-hop paths. However, the algorithms described above were designed in consideration of wired networks and may not be efficient when applied directly to wireless networks.

A wireless network has unique properties compared to the wired network and requires a scheduler design that considers these properties. Some of the properties of the wireless network are as follows. In a wireless network, the channel capacity may vary according to the position of the user and according to time. Also, changes in channel status may cause errors during packet transmission, and when an error occurs for a packet, a retransmission of the packet is needed. As an existing scheduling algorithm for a wireless network, an algorithm has been proposed for supporting constant bitrate (CBR) traffic for a single-hop wireless network that uses a Markov decision process (MDP). Expanding on this method, Channel-Aware EDD (CA-EDD) was proposed as a scheduling algorithm that considers both delay bounds and channel status and uses dynamic programming (DP). However, these algorithms were designed for a downlink wireless network and do not consider packet transmission having multi-hop paths.

### SUMMARY

An aspect of the invention proposes a device and method for scheduling packet transmission that can transmit packets efficiently in a multi-hop network.

One aspect of the invention provides a device for scheduling packet transmission that includes: an interface unit configured to transmit and receive a packet; a controller configured to calculate a local time and an ARQ time from a packet to be transmitted, where the local time is determined in proportion to a packet delay bound, and the ARQ time is determined based on the local time and the packet delay bound; a queue in which the packet to be transmitted is inputted; and a scheduler configured to determine a transmission order of packets inputted in the queue based on at least one of the local time and the ARQ time.

The queue may include a retransmission packet queue, in which a packet that is to be retransmitted is inputted, and an initial transmission packet queue, in which a packet that is to be transmitted initially is inputted.

The controller may use the local time first and then use the ARQ time when calculating the local time and the ARQ time.

When the ARQ time for a particular packet becomes 0 or lower, then the packet may be dropped.

In a multi-hop network, the local time may be set for each node, and the ARQ time may be set to a fixed value regardless of node.

If not all of the local time is used for a packet at a particular node transmitting the packet in the multi-hop network, the remaining local time may be added to the ARQ time to modify the ARQ time.

The controller may determine whether or not the packet to be transmitted is a retransmitted packet and may input the packet to the retransmission packet queue if the packet is a retransmitted packet and input the packet to the initial transmission packet queue if the packet is not a retransmitted packet.

The scheduler may assign a higher priority level to packets standing by in the retransmission packet queue than to packets standing by in the initial transmission packet queue.

The scheduler may determine priority levels for packets standing by in the initial transmission packet queue by using the local times.

The scheduler may determine priority levels for packets standing by in the retransmission packet queue by using the ARQ times.

If a particular packet from among the packets standing by in the initial transmission packet queue uses up all of its local time, then the controller may input the packet in the retransmission packet queue.

When a packet is received from a new flow, the controller may determine whether or not to accept the packet from the new flow.

The controller may determine whether or not to receive the packet from the new flow by considering the probability of a delay bound being violated and the processing capacity that would be required if the new packet is received.

Another aspect of the invention provides a method for scheduling packet transmission that includes: (a) inputting a packet to be transferred in a queue; (b) calculating a local time and an ARQ time from the packet to be transmitted, the local time determined in proportion to a packet delay bound, the ARQ time determined based on the local time and the packet delay bound; and (c) determining a priority level of the packet to be transmitted based on at least one of the local time and the ARQ time.

A method and device for scheduling packet transmission according to certain embodiments of the invention provide the advantage of efficient packet transmission in a multi-hop wireless network.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates an example of a communication system to which a method for scheduling packet transmission based on an embodiment of the invention may be applied.

FIG. 2 illustrates a header structure for a transmitted packet according to an embodiment of the invention.

FIG. 3 illustrates changes in local time and ARQ time when a packet is transmitted according to an embodiment of the invention.

FIG. 4 is a block diagram of a device for scheduling packet transmission according to an embodiment of the invention.

FIG. 5 illustrates the structure of a multi-queue 404 according to an embodiment of the invention.

FIG. 6 is a flowchart illustrating the flow of a method for scheduling packet transmission according to an embodiment of the invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

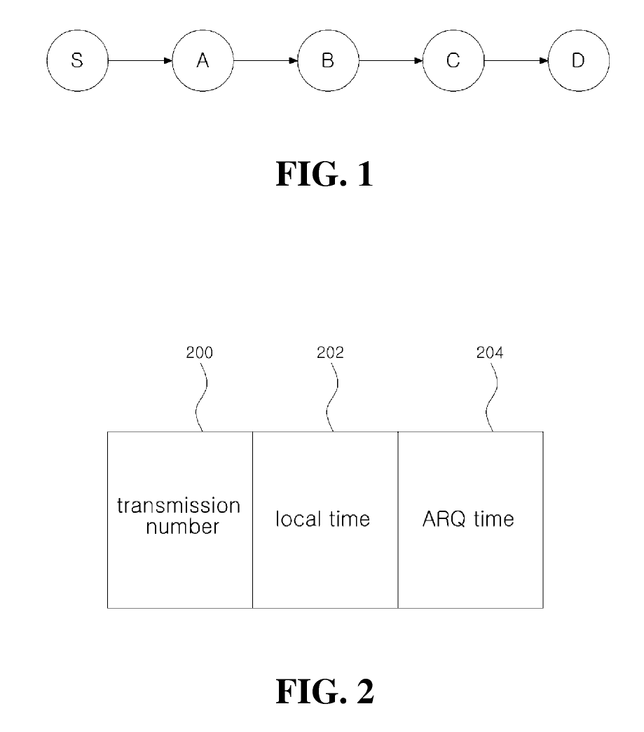

FIG. 1 illustrates an example of a communication system to which a method for scheduling packet transmission based on an embodiment of the invention may be applied.

Referring to FIG. 1, a communication system to which a packet transmission scheduling method according to an embodiment of the invention is applied can include multiple nodes and may be a multi-hop network communication system in which packets are transmitted over multiple relay nodes A, B, C from a source node S to a destination node D.

A packet may be transmitted from the source node S, and the relay nodes A, B, C may relay the packet such that the packet transmitted from the source node S reaches the destination node D.

In a conventional method of scheduling packet transmission, a variable called “delay bound” may be used to determine whether or not to drop a packet. For example, a scheduling for packet transmission may entail assigning a delay bound for each hop, and dropping the packet if the delay bound is exceeded at a particular hop.

Also, if a transmission error occurs during a packet transmission, a retransmission from the source node S of the packet for which the error occurred may be requested, and the source node S may again transmit the packet of which retransmission was requested. The retransmission can take place over several rounds, and if the time lapsed for the initial transmission and the retransmission exceeds the delay bound, the packet may be dropped.

Also, in a conventional packet transmission scheduling method, priority levels may be set for packets standing by in a queue based on the delay bounds assigned to each packet, where a packet having a smaller delay bound may be given higher priority over a packet having a larger delay bound.

A device for scheduling packet transmission according to an embodiment of the invention may be equipped for each node, to assign priority levels to the packets provided to each node for transmitting the packets.

A packet transmit scheduling based on an embodiment of the invention may schedule packet transmission by using two variables, the local time and the ARQ (Automatic Repeat Request) time.

The local time refers to the time allotted at a transmitting node for each hop in a multi-hop network, and may serve as a basis for setting priority levels for the packets. That is, when multiple packets are standing by in a queue at a transmitting node, the priority levels for packet transmission may be determined based on the local times of the respective packets.

The ARQ time may serve as a basis for determining whether or not a packet is to be dropped and may also be used in setting the priority levels of the packets when necessary. When the ARQ time of a particular packet reaches 0, the packet may be dropped.

Using i to represent a flow, n to represent a node, D, to represent the delay bound at flow i, and Nᵢ to represent the total number of nodes, the local time d_{i,n} at each node can be defined by Equation 1 shown below.

d_{i,n}=(1−α)Dᵢ/(Nᵢ−1) [Equation 1]

As can be seen from Equation 1 above, the local time is a variable that is proportional to the delay bound. The weight variable a for used in determining the local time may be determined according to the level of importance of the packet.

The ARQ time may be determined by the delay bound and the established local time. The following Equation 2 expresses the ARQ time allotted to the q-th packet at node n for flow i.

$${a}_{i , n}^{q} = \{ \begin{matrix}{D}_{i} - {\sum }_{j = 1}^{{N}_{i} - 1} {d}_{i , j} , & n = 1 \\ {d}_{i , n - 1} + {a}_{i , n - 1}^{q} - {s}_{i , n - 1} - {τ}_{i , n - 1}^{q} , & n > 1\end{matrix} \qquad [ Equation 2 ]$$

In Equation 2 above, s_{i,n} represents service time, and τ^{q}_{i,n} represents a sum of the queuing delay time and transmission delay time for the q-th packet.

When transmitting a packet, the local time may be expended first, and the ARQ time may be expended when all of the local time has been expended. Since the local time is expended first and the ARQ time is expended afterwards, having the ARQ time reach 0 is the same as reaching the delay bound, and hence the packet may be dropped.

If not all of the local time was expended in a first hop, in which a packet was transmitted from a first node to a second node, then the remaining local time may be added to the ARQ time in the second hop. For example, if the local time were 1 second at the first hop and 0.5 seconds were used in the first hop so that 0.5 seconds of the local time is left remaining, then the remaining local time may be added to the ARQ time.

FIG. 2 illustrates a header structure for a transmitted packet according to an embodiment of the invention.

Referring to FIG. 2, a packet for which a packet scheduling method according to an embodiment of the invention is used can include a transmission number field 200, a local time field 202, and an ARQ time field 204 as header information.

In the transmission number field 200, the information for checking whether the packet is a retransmitted packet may be recorded. For instance, flag information can be recorded for checking for retransmission, or information on the specific number of transmissions can be recorded.

For example, flag information can be recorded in the transmission number field 200, with “0” representing an initial transmission and “1” representing a retransmitted packet.

In the local time field 202, information regarding the local time initially set at the transmitting node may be recorded. The local time recorded in the local time field 202 may be used as information for setting the priority levels of packets in a queue.

In the ARQ time field 204, information on the remaining ARQ time may be recorded. As described above, when all of the ARQ time is expended, the corresponding packet may be dropped.

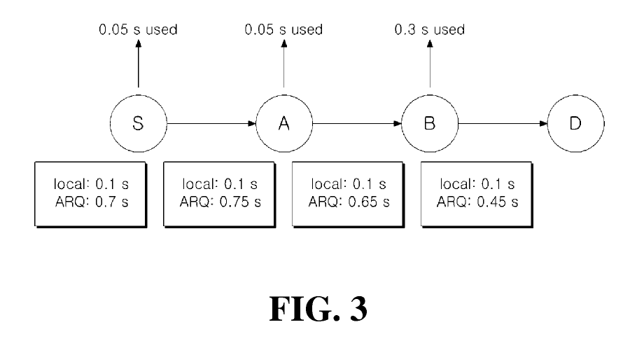

FIG. 3 illustrates changes in local time and ARQ time when a packet is transmitted according to an embodiment of the invention.

Referring to FIG. 3, a communication system is illustrated that is composed of a source node S, two relay nodes A, B, and a destination node D, where a packet is transmitted from the source node S to the destination node D in the order of S-A-B-D. That is, the packet is transmitted from the source node S to the destination node D over through hops.

Suppose that the total delay bound is 1 second, and that the local time assigned to the transmitting node for each hop is 0.1 second. As there are three hops, the total sum of the local times assigned to the transmitting nodes of the respective hops is 0.3 seconds, and therefore the ARQ time is 0.7 seconds.

Suppose 0.05 seconds are expended in the first hop until the transmitting node transmitted the packet. Then, in the first hop, not all of the local time is used, and 0.05 seconds of the local time remains.

The source node S of the first hop may add the remaining local time, 0.05 seconds, to the ARQ time, and the packet reflecting the modified ARQ time information may be transmitted to the first relay node A. Since 0.05 seconds of additional ARQ time was provided, the local time is 0.1 second and the ARQ time is 0.75 seconds at the first relay node A.

If 0.2 seconds are expended at the first relay node A in transmitting the packet (including the transmission delay in the first hop), then 0.1 second of the local time is expended, and 0.1 second of the ARQ time is then used. Here, the ARQ time is changed from 0.75 seconds to 0.65 seconds.

The first relay node A may incorporate the changed ARQ time in the header information and transmit the packet to the second relay node.

If 0.3 seconds are expended at the second relay node B in transmitting the packet to the destination node D (including the transmission delay in the second hop), then 0.1 second of the local time is expended, and 0.2 seconds of the ARQ time are then used. Thus, the ARQ time is changed from 0.65 seconds to 0.45 seconds.

The second relay node B may incorporate the changed ARQ time in the header information and transmit the packet to the second relay node.

As seen in FIG. 3, each transmitting node, when transmitting a packet, may first use the local time and may use the ARQ time when the local time is used up. When all of the ARQ time is expended, the corresponding packet may be dropped.

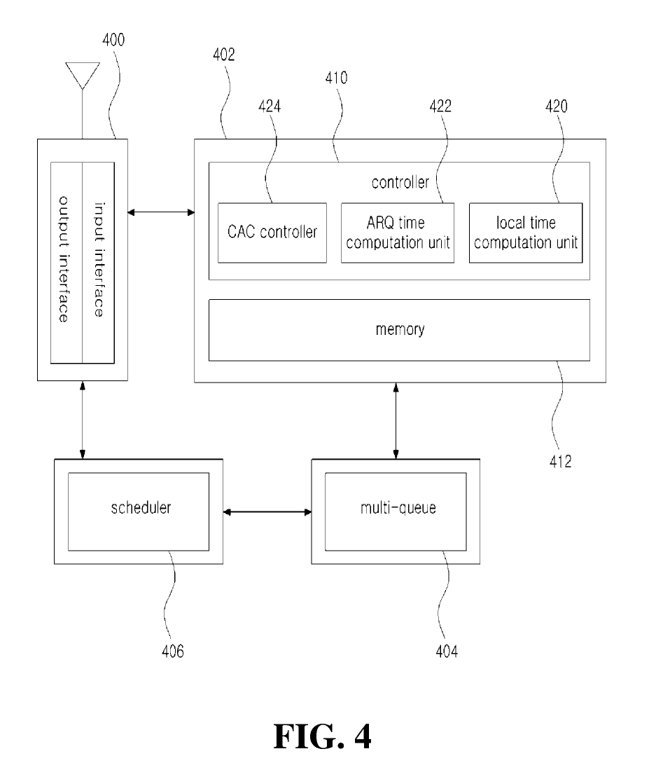

FIG. 4 is a block diagram of a device for scheduling packet transmission according to an embodiment of the invention.

The packet transmission scheduling device illustrated in FIG. 4 may be equipped at each node of a multi-hop network.

Referring to FIG. 4, a packet transmission scheduling device according to an embodiment of the invention may include an input/output interface unit 400, a processor unit 402, a multi-queue 404, and a scheduler 406.

The processor unit 402 may include a controller 410 and a memory device 412, and the controller 410 may include a local time computation unit 420, an ARQ time computation unit 422, and a CAC (Call Admission Control) controller 424.

The input/output interface unit 400 may include an input interface and an output interface. The data received from other nodes may be inputted via the input interface. The data to be transmitted from the node may be outputted via the output interface.

The controller 410 may serve to determine whether or not a packet received via the input interface is to be inputted to the multi-queue 404 and to manage the ARQ time and local time of a packet.

The local time computation unit 420 of the controller may analyze the header information of a packet received via the input interface to check the local time of the packet and may measure the amount of local time expended. The local time computation unit 420 of a source node, where the packet is generated, may compute the local time of the generated packet. The local time can be computed as in Equation 1.

The ARQ time computation unit 422 may check the ARQ time recorded in the packet received from the input interface. Also, the ARQ time computation unit 422 may measure the amount of ARQ time expended. The ARQ time computation unit 422 may lastly check the duration of time for which the packet remained at the node and may update the ARQ time when the packet is outputted via the output interface.

When a packet of a new flow is received, the CAC controller 424 may determine whether or not to process the packet of the flow. Here, a flow can be defined as a source from which a packet is generated. For example, a first flow can be a flow for streaming packets transmitted from a particular video server, while a second flow can be a flow for game data packets transmitted from a game server.

The CAC controller 424 may determine whether or not to process the new packet in consideration of the probability of violating a delay bound if the packet of the new flow were to be processed and the processing capacity of the node for guaranteeing QoS. The CAC controller 424 may accept and process a packet of a new flow if the probability of violating a delay bound is lower than or equal to a preset threshold and if the processing capacity for guaranteeing QoS is smaller than or equal to the maximum processing capacity of the node.

According to an embodiment of the invention, the probability of violating the delay bound for a flow i can be computed as in Equation 3 shown below.

$${P}_{DBV , i} = 1 - {\sum }_{i = 0}^{{r}_{i}} ( \begin{matrix}{N}_{i} + i - 2 \\ i\end{matrix} ) {{p}^{i} ( 1 - p )}^{{N}_{i} - 1} \qquad [ Equation 3 ]$$

In Equation 3, Nᵢ represents the number of nodes for the flow i, and p represents the probability of an error occurring.

Also, the condition for the processing capacity required when the new flow is accepted exceeding the maximum processing capacity of the node can be expressed as Equation 4 shown below.

Σ_{∀i∈V}_{ₙ}2sᵢ/x_{min,i}<1 [Equation 4]

In Equation 4, Sᵢ represents the service time for each flow, Vₙ represents the set of traffic flows transmitted initially, and x_{min,i} represents the minimum interval between arriving packets for each flow.

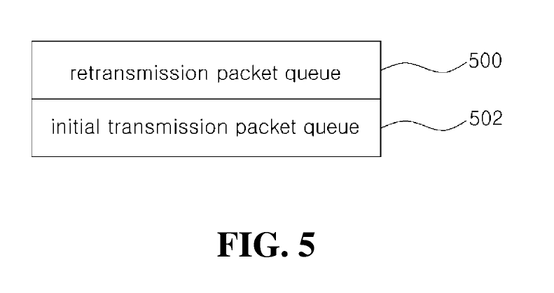

In a multi-queue 404, the packets that are to be processed may be inputted and placed in a standby state. FIG. 5 illustrates the structure of a multi-queue 404 according to an embodiment of the invention.

Referring to FIG. 5, a multi-queue 404 according to an embodiment of the invention may include a retransmission packet queue 500 and an initial transmission packet queue 502.

The retransmission packet queue 500 may be a queue for packets that have experienced a failure in transmission and are to be retransmitted, and the initial transmission packet queue 502 may be queue for packets that are being transmitted for the first time from a source node. The retransmission packet queue 500 can also include packets for which the local time was used up during standby in the initial transmission packet queue 502.

One reason for having the packet transmission scheduling device according to an embodiment of the invention place the retransmitted packets and initially transmitted packets in different queues is that the scheduler 406 may transmit the packets with different priority levels assigned for each queue.

The packets waiting in the retransmission packet queue 500 may be assigned higher priority levels compared to the packets waiting in the initial transmission packet queue 502.

The scheduler 406 may determine the transmission order of the packets according to the priority levels of the packets placed in standby in the queues, and may provide the input/output interface unit with the packets that are to be transmitted.

As described above, the scheduler 406 may assign higher priority to packets that are being retransmitted (i.e. packets waiting in the retransmission packet queue 500) compared to packets that are transmitted for the first time (i.e. packets waiting in the initial transmission packet queue 502).

The packets standing by in the retransmission packet queue 500 may be packets for which the local times have been used up, and as such, the priority levels for the packets standing by in the retransmission packet queue 500 may be set based on the remaining ARQ times.

The priority levels for the packets standing by in the initial transmission packet queue 502 may be set based on the local times.

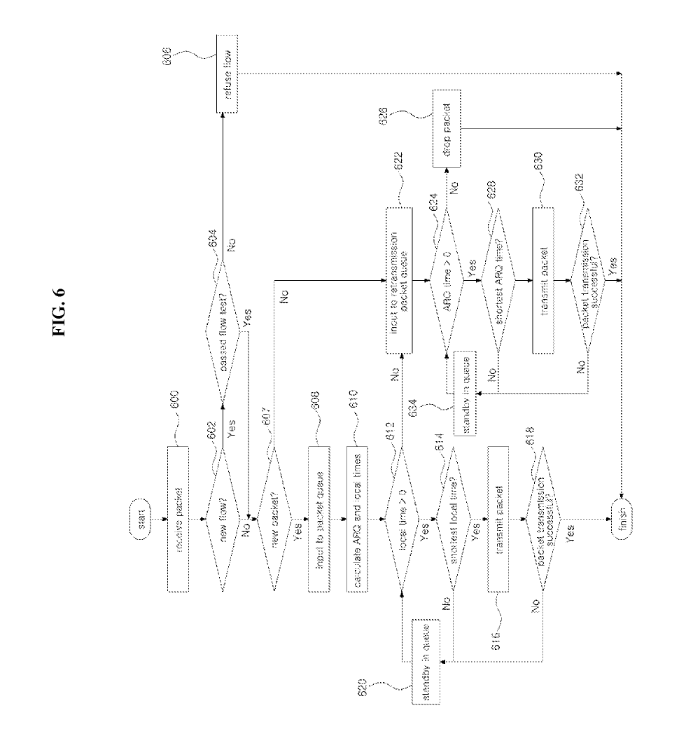

FIG. 6 is a flowchart illustrating the flow of a method for scheduling packet transmission according to an embodiment of the invention.

Referring to FIG. 6, a packet may first be received at a device for scheduling packet transmission (operation 600).

When a packet is received, it may be determined whether or not it is a packet from a new flow (operation 602). If it is a packet from a new flow, the CAC controller 424 may determine whether or not the packet from the new flow is to be accepted (operation 604). As described above, the determining of whether or not the packet from a new flow is to be accepted may consider the probability of delay bound violation and the node's processing capacity.

If the probability of delay bound violation exceeds a preset threshold or if the processing capacity exceeds the maximum processing capacity of the node, the packet from the flow may be refused (operation 606).

If the packet is not from a new flow, it may be determined whether the packet is a retransmitted packet or an initially transmitted packet (operation 607).

If it is an initially transmitted packet, the packet may be inputted to the initial transmission packet queue (operation 608), and if it is a retransmitted packet, the packet may be inputted to the retransmission packet queue (operation 622).

Once the packet is inputted to a queue, the local time and the ARQ time of the packet may be computed continuously (operation 610).

If all of the local time is used up while in the initial transmission packet queue (operation 612), then the packet for which the local time has been used up may be inputted to the retransmission packet queue (operation 622).

In the case of an initially transmitted packet, it may be determined whether or not the packet has the shortest local time from among the packets standing by in the initial transmission packet queue (operation 614).

If it has the shortest local time, then the packet may be transmitted (operation 616). Then, after the packet transmission, it may be determined whether or not the transmission was successful (operation 618).

If the packet does not have the shortest local time or if a failure occurs during transmission, then the packet may maintain its standby state in the queue (operation 620).

As described above, if a received packet is not an initially transmitted packet, or even though it is an initially transmitted packet, if all of the local time has been used up while in the initial transmission packet queue, then the packet may be inputted to the retransmission packet queue (operation 622).

For a packet waiting in the retransmission packet queue, it may be determined whether or not the ARQ time is greater than 0 (operation 624). If the ARQ time of the packet is 0 or less, then the packet may be dropped (operation 626).

In the retransmission packet queue, the priority levels may be set by using the ARQ times, and hence it may be determined whether or not a packet has the shortest ARQ time from among the packets standing by in the retransmission packet queue (operation 628). If it has the shortest ARQ time, then the packet may be transmitted (operation 630).

It may then be determined whether or not the packet was transmitted successfully (operation 632), and if the transmission of the packet was not successful or if the packet does not have the shortest ARQ time, the packet may maintain its standby state in the retransmission packet queue (operation 634).

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A device for scheduling packet transmission, the device comprising:
an interface unit configured to transmit and receive a packet;
a controller configured to calculate a local time and an ARQ time from a packet to be transmitted, the local time determined in proportion to a packet delay bound, the ARQ time determined based on the local time and the packet delay bound;
a queue having inputted therein the packet to be transmitted; and
a scheduler configured to determine a transmission order of packets inputted in the queue based on at least one of the local time and the ARQ time.

2. The device for scheduling packet transmission of claim 1, wherein the queue comprises a retransmission packet queue and an initial transmission packet queue, the retransmission packet queue having inputted therein a packet that is to be retransmitted, the initial packet queue having inputted therein a packet that is to be transmitted initially.

3. The device for scheduling packet transmission of claim 2, wherein the controller uses the local time first and then uses the ARQ time when calculating the local time and the ARQ time.

4. The device for scheduling packet transmission of claim 3, wherein a particular packet of which the ARQ time is 0 or lower is dropped.

5. The device for scheduling packet transmission of claim 3, wherein the local time is set for each node in a multi-hop network, and the ARQ time is set to a fixed value regardless of node.

6. The device for scheduling packet transmission of claim 5, wherein, if not all of the local time is used for a packet at a particular node transmitting the packet in the multi-hop network, the remaining local time is added to the ARQ time to modify the ARQ time.

7. The device for scheduling packet transmission of claim 2, wherein the controller determines whether or not the packet to be transmitted is a retransmitted packet and inputs the packet to the retransmission packet queue if the packet is a retransmitted packet and inputs the packet to the initial transmission packet queue if the packet is not a retransmitted packet.

8. The device for scheduling packet transmission of claim 7, wherein the scheduler assigns a higher priority level to packets standing by in the retransmission packet queue than to packets standing by in the initial transmission packet queue.

9. The device for scheduling packet transmission of claim 8, wherein the scheduler determines priority levels for packets standing by in the initial transmission packet queue by using the local times.

10. The device for scheduling packet transmission of claim 8, wherein the scheduler determines priority levels for packets standing by in the retransmission packet queue by using the ARQ times.

11. A method for scheduling packet transmission, the method comprising:
(a) inputting a packet to be transferred in a queue;
(b) calculating a local time and an ARQ time from the packet to be transmitted, the local time determined in proportion to a packet delay bound, the ARQ time determined based on the local time and the packet delay bound; and
(c) determining a priority level of the packet to be transmitted based on at least one of the local time and the ARQ time.

12. The method of claim 11, wherein the queue comprises a retransmission packet queue and an initial transmission packet queue, the retransmission packet queue having inputted therein a packet that is to be retransmitted, the initial packet queue having inputted therein a packet that is to be transmitted initially.

13. The method of claim 11, wherein the local time is used first and the ARQ time is used afterwards, once the local time and the ARQ time are calculated.

14. The method of claim 11, wherein a particular packet of which the ARQ time is 0 or lower is dropped.

15. The method of claim 11, wherein the local time is set for each node in a multi-hop network, and the ARQ time is set to a fixed value regardless of node.

16. The method of claim 13, wherein, if not all of the local time is used for a packet at a particular node transmitting the packet in the multi-hop network, the remaining local time is added to the ARQ time to modify the ARQ time.

17. The method of claim 12, wherein the inputting comprises determining whether or not the packet to be transmitted is a retransmitted packet and inputting the packet to the retransmission packet queue if the packet is a retransmitted packet and inputting the packet to the initial transmission packet queue if the packet is not a retransmitted packet.

18. The method of claim 17, wherein the determining of the priority level comprises assigning a higher priority level to packets standing by in the retransmission packet queue than to packets standing by in the initial transmission packet queue.

19. The method of claim 17, wherein the determining of the priority level comprises determining priority levels for packets standing by in the initial transmission packet queue by using the local times.

20. The method of claim 17, wherein the determining of the priority level comprises determining priority levels for packets standing by in the retransmission packet queue by using the ARQ times.
